(19) United States
(12) Patent Application Publication
(10) Pub. No.: US 2003/0233277 A1
(43) Pub. Date: Dec. 18, 2003

(54) System and method for issuing, tracking, fulfilling and analyzing rainchecks

(76) Inventors: David Saunders, St. Paul, MN (US); Karen Koewler, Chaska, MN (US); Nicholas Schwendeman, Hastings, MN (US)

Correspondence Address: Beck & Tysver, P.L.L.C., Suite 100, 2900 Thomas Avenue S., Minneapolis, MN, 55416, US

(21) Appl. No.: 10/283,420

(22) Filed: Oct. 29, 2002

Related U.S. Application Data
(60) Provisional application No. 60/389,254, filed on Jun. 17, 2002.

(51) Int. Cl. G06F 17/60

(52) U.S. Cl. 705/14

(57) ABSTRACT

An automated system issues and tracks the fulfillment of rainchecks given to customers when an advertised promotion is out-of-stock.

This application claims priority from provisional application U.S. Ser. No. 60/389,254, filed Jun. 17, 2002.

### FIELD OF THE INVENTION The present invention relates generally to raincheck fulfillment and more particularly to a system and method for issuing, tracking, and fulfilling rainchecks and using data captured by the system to inform inventory decisions and actions and to yield useful information for business management.

### BACKGROUND OF THE INVENTION

A “raincheck” is an instrument by which a customer can purchase goods at a discount or according to the terms of a promotion even though the period for such a discount or promotion has passed. Rainchecks are issued to customers who have attempted to purchase a product during the discount period, but found that the store had none of the items in stock. With a raincheck, the customer can purchase the product when it becomes available at the advertised price, even though the time period for the lower price or promotion may have passed by the time the item gets re-stocked.

FIG. 1 illustrates, via a flow chart, a typical existing system for issuing and processing rainchecks in a retail setting. When a store runs out of stock for a product, a box containing paper rainchecks is placed in the product's spot on the store shelf (10). The customer fills out the paper raincheck (11), filling in their name, address, the item, its price and the like. Typically, these rainchecks are multi-layered carbon copy forms. The top form is kept by the customer (12), and the remaining copy or copies are stored by the store, such as in a “raincheck box” (13). Periodically, the store copies of the rainchecks are filed in the store (14). When the store receives inventory of the rainchecked item, one copy of the raincheck form is taped to one unit of the product (15) and the marked product is stored for the customer. A third copy of the raincheck is mailed to the customer (16) to alert the customer that the rainchecked item has been re-stocked. If the customer returns to the store within a designated period of time, the customer's marked product is retrieved from storage (17). If the customer does not return for the product, the raincheck copy is removed from the item and the item is placed on the store shelves (18).

The steps (20) indicated within the dotted line in FIG. 1 represent actions taken in collecting data from the rainchecks, processing this data, passing it from one software application to another and analyzing it.

Rainchecks have commonly been paper documents given to the customer to present upon their return to the store. Upon issuance, the store typically keeps one or two paper copies or carbon copies of the raincheck for its records. Periodically, the rainchecks are keyed into a database. Tracking the rainchecks, to advise customers that their rainchecked items have been re-stocked, has been manual and typically inconsistent. Tracking the rainchecks has been cumbersome and time consuming for store personnel.

### SUMMARY OF THE INVENTION

What has been needed is a more automated system for handling rainchecks and attending to the tracking and fulfillment of rainchecked items. Further, what has been needed is a system which collects and mines data regarding the issuance and fulfillment of the rainchecks. According to one aspect of the system and method of this invention, a raincheck is entered into a database containing records for each raincheck by a store employee at a store location. Via networked computers, an inventory analyst can view data regarding rainchecked items, order a shipment of rainchecked items to those store locations who are in need, and communicate with the stores to advise them of action taken to supply their need.

Further, the system and method involves the automated generation of a message to the consumer to indicate that a rainchecked item is now available. Because this information can be made available to any physical location via networked computers, paper messages can be generated and mailed to customers without having to involve the store personnel. For example, the mail center can generate the messages, without any direct involvement of the store personnel. Further, email messages can be generated, in lieu of or in addition to paper messages, and automatically forwarded to customers when stock is available in the store.

Still further, the system and method provide for a label for marking inventory to designate it to fulfill a particular issued raincheck.

The system supports a variety of reporting functions to supply useful information regarding rainchecks and inventory management.

### BRIEF DESCRIPTION OF THE DRAWINGS

An exemplary version of a raincheck fulfillment process and system is shown in the figures wherein like reference numerals refer to equivalent structure throughout, and wherein:

FIG. 1 is a flow chart showing a prior art method of issuing, tracking and fulfilling rainchecks;

FIG. 2 is a flow chart showing the process of issuing and fulfilling rainchecks according to the present invention;

FIG. 3 is a software architecture diagram for implementing the raincheck system and method of FIG. 2;

FIG. 4 is a map of a database for use in the raincheck system and method of FIG. 2;

FIG. 5 is a diagram of the flow of information amongst store locations, the business tier and auxiliary business functions via a raincheck database according to the present invention.

FIG. 6 is a sample raincheck generated according to the system and method of FIG. 2;

FIG. 7 is a sample Raincheck Order Activity Report generated according to the system and method of this invention;

FIG. 8 is a sample “In-Stock” sheet or label generated according to the system and method of FIG. 2; and

FIG. 9 is a sample mailer generated according to the system and method of FIG. 2.

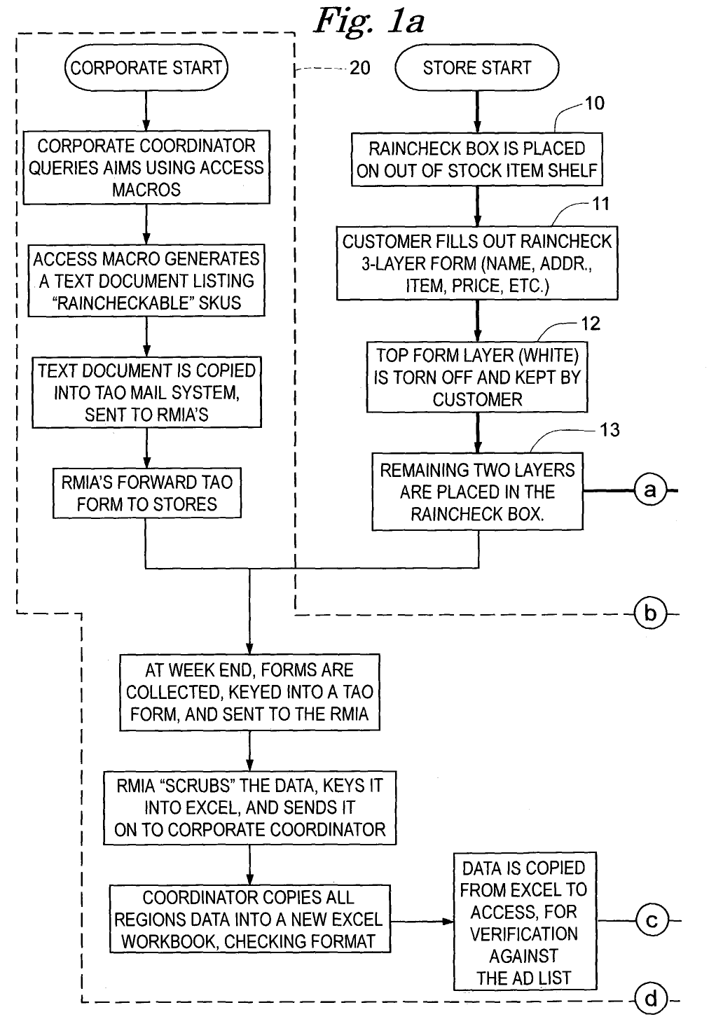

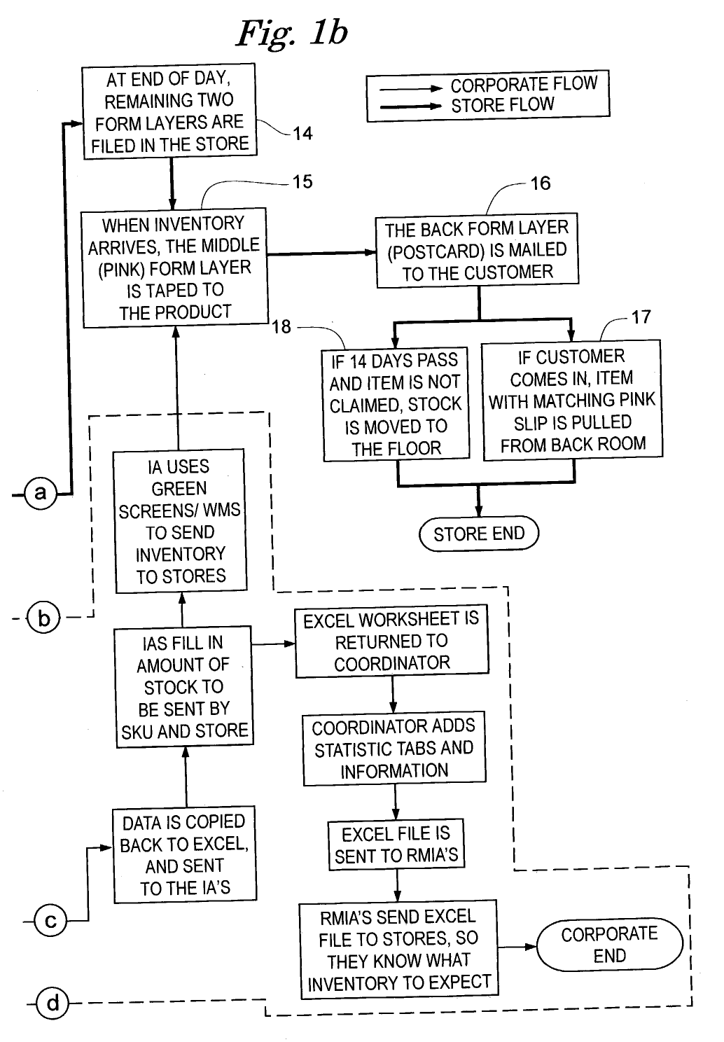

### DETAILED DESCRIPTION OF A PREFERRED EMBODIMENTS(S)

A preferred embodiment of a raincheck system and method facilitates the issuing, tracking and fulfillment of rainchecked items. As illustrated in FIG. 5, the system 100 promotes the exchange of information between and amongst several entities which typically operate at different physical locations. It should be understood that this system 100 may also be used when only one entity at one location is involved; typically, though, a retail operation involves multiple entities at multiple locations. More specifically, a typical retail operation involves one or more retail locations or stores 110 supported by business functions 190 that typically are located remotely from the stores 100. The retail operation is typically supported by auxiliary functions 130, such as warehouse space(s) 131 from which the stores replenish inventory, and a mail room or mail center 132.

The preferred raincheck system 100 incorporates a raincheck database 140 for collecting, storing and processing information about rainchecks issued from any store 110. Preferably, this database 140 is accessible to many employees at many locations across the retail operation, though security clearances control the extent to which the database information is available to each employee. Each store 110 is equipped with a data entry and display station 150 for entering data to issue a raincheck and to display information about rainchecks. This data entry and display station 150 may be a computer terminal, a personal computer, a kiosk, a handheld computer or any other device that has user input capability, such as a keyboard, mouse, or touchscreen, and a display screen. The input device and the display screen may be integral with the data entry and display station, such as with a handheld digital device or kiosk, or may be separate components linked for data transmission, such as with a personal computer, keyboard, mouse and monitor. The data entry and display station 150 is linked or networked to the raincheck data base 140 for data transmission therebetween. In typical applications, the database 140 will be stored on a computer physically remote from the data entry and display stations 150 and will be networked via internet or intranet and may be wired or wireless.

Each store 110 will have a printer 160 linked or networked to the data entry and display station 150, such that the an employee can enter a command at the station 150 to print a raincheck or other raincheck-related document or report to the printer 160.

In a preferred embodiment, the cashier registers 170 at each store are linked for data communication with the raincheck system 100. Thus, the register can access data from a raincheck record when a customer checks out with their rainchecked item, and the appropriate price will be charged at the register 170. This will be described in greater detail below.

Each store 110 also has one or more storage locations 180 for rainchecked items when they are re-stocked so that they can be set aside for the raincheck customer for a limited time.

The raincheck database 140 provides information to the business tier 190 of the retail operation about the operation's rainchecks. For example, inventory analysts 191 can access the database to identify goods that need to be shipped to stores to satisfy issued rainchecks. Inventory analysts and other management functions 192 can access the database to identify inventory problems, to monitor the proficiency with which rainchecks are issued and fulfilled, to monitor costs associated with rainchecks and the like.

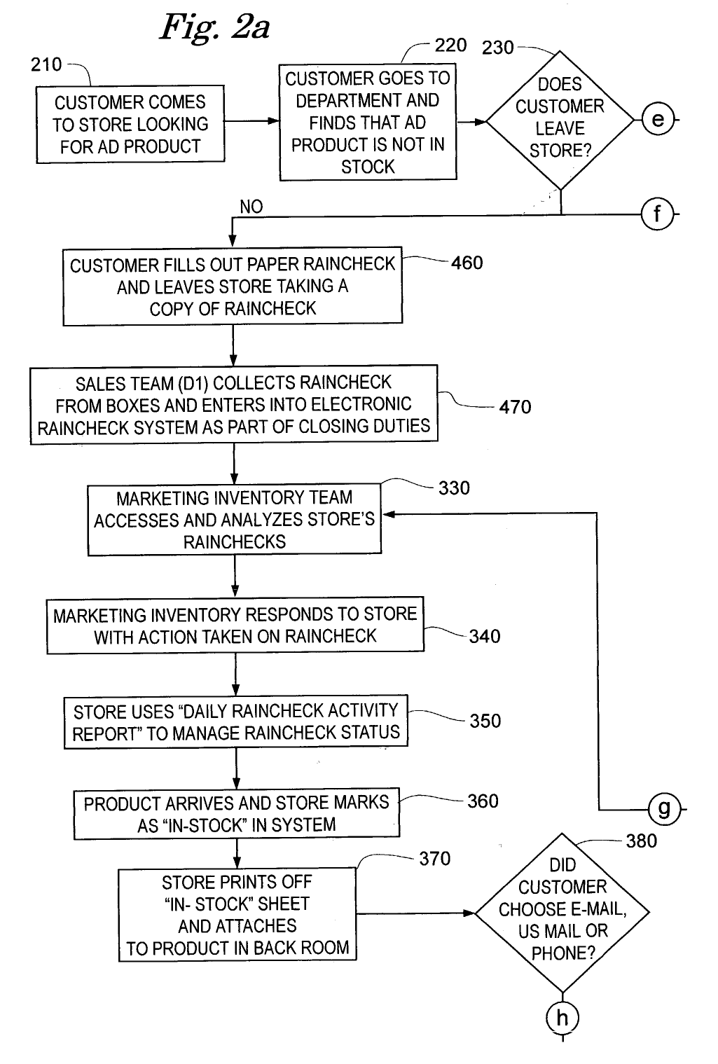

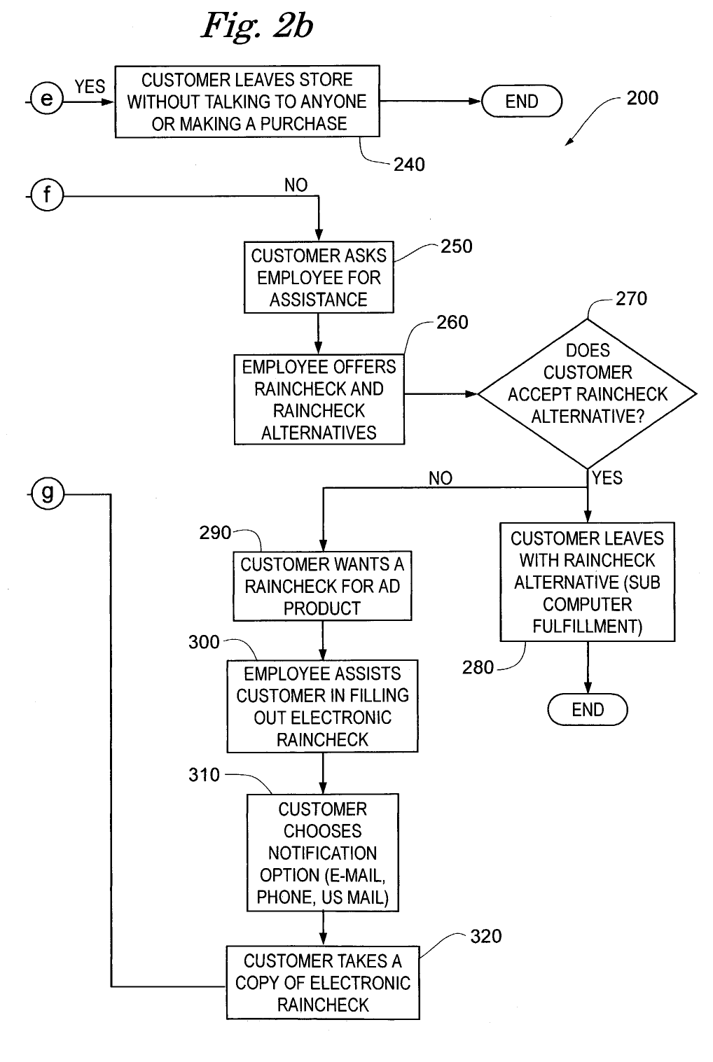

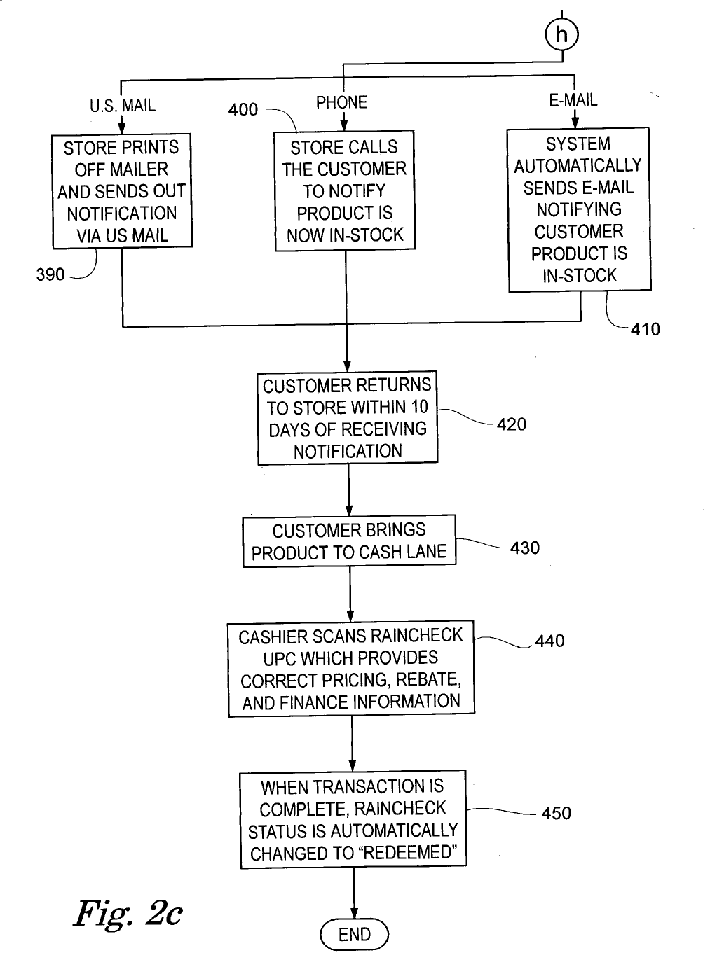

FIG. 2 illustrates the process (200) by which a raincheck is issued and redeemed. A customer comes to a retail store 110 seeking an advertised product (210). When the customer finds that the advertised product is not in stock (220), the customer faces a choice (230) whether to leave the store (240) or to take further action to get the product. In some cases, the customer will ask an employee for assistance (250). The employee will offer the customer a raincheck for the out-of-stock item and will offer an alternative product for the same discount or price (260). The use of the raincheck system 100 to identify substitute products will be noted below. If the customer chooses to accept the substituted product (270), the customer leaves the store with the substituted product (280) and no further action is required for this customer.

If the customer opts to take a raincheck rather than the substitute product (290), then the employee assists the customer in filling out an electronic raincheck (300). This involves filling out a template or form using the data entry and display station 150. At a minimum, the employee will fill in a product identifier, typically its sku number, and a customer identifier. If more than one product is implicated in the transaction (for example, if several products are offered together at a package sale price), the employee will enter each sku number. Preferably, the system allows the employee to identify the products by model number or other identifying information, as an alternative to the sku number.

The employee enters the customer name and address. If data about the customer is on hand (i.e. if a record exists for the customer in the raincheck database or in a related or associated database for the retail operation), the employee may be able to look-up or automatically fill address or other contact information. For example, through look-up or search functions, the employee may be able to access a customer record using their phone number or other customer-specific information. The customer elects (310) how he/she would like to be notified when the product is stocked and this election is stored in the raincheck record in the database 140. Notification options include email, U.S. mail, or telephone call.

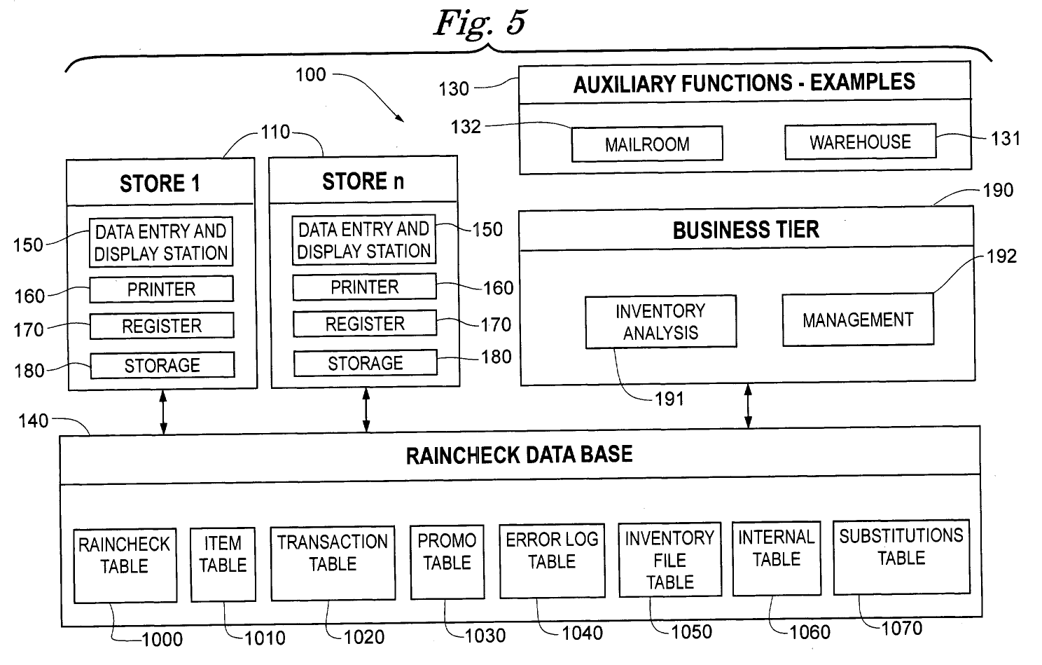

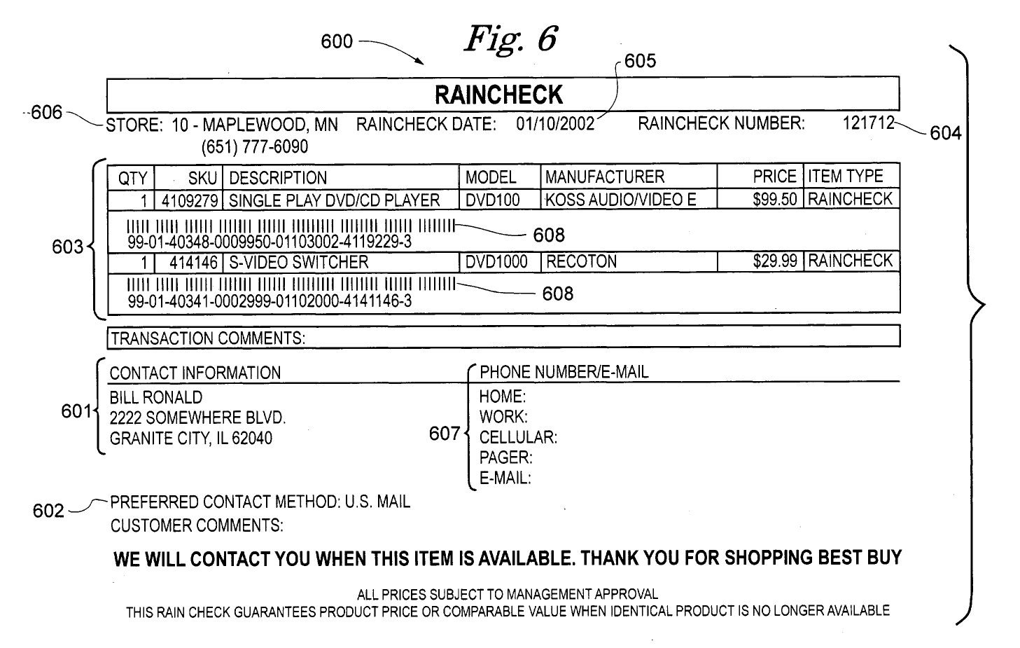

The store employee then prints (320) a raincheck 600 to give to the customer. This raincheck 600 is generated by the database 140 populating fields in a raincheck template. FIG. 6 shows a sample printed raincheck 600. The raincheck 600 includes contact information 601, an indication 602 of the customer's selected notification method, and identification 603 of the rainchecked items. In the example illustrated, two items are listed on the raincheck 600. The product identification section 603 includes the quantity, sku, product description, model identification, name of the manufacturer of the product and the price. The raincheck 600 also include the raincheck's unique identifier 604, the date 605 of issuance of the raincheck and an identifier 606 for the store which issued the raincheck. For the customer's convenience, the store phone number is listed. In the example illustrated, the customer's phone and email information 607 is blank, since the customer's selected notification method is US mail.

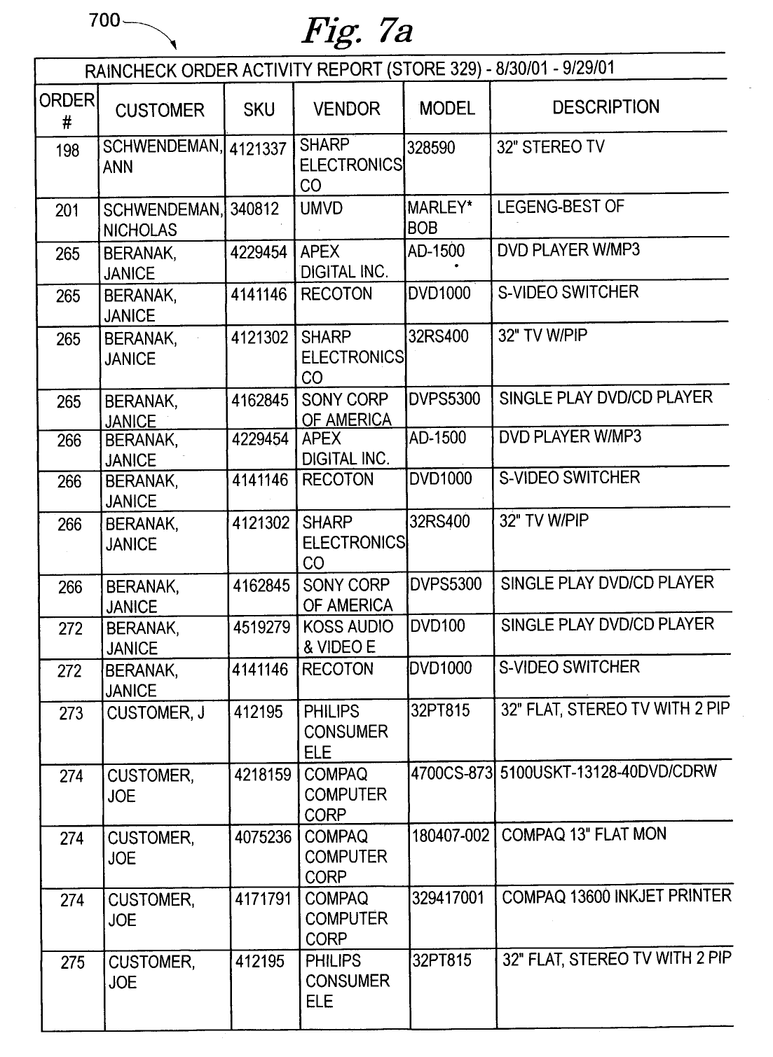

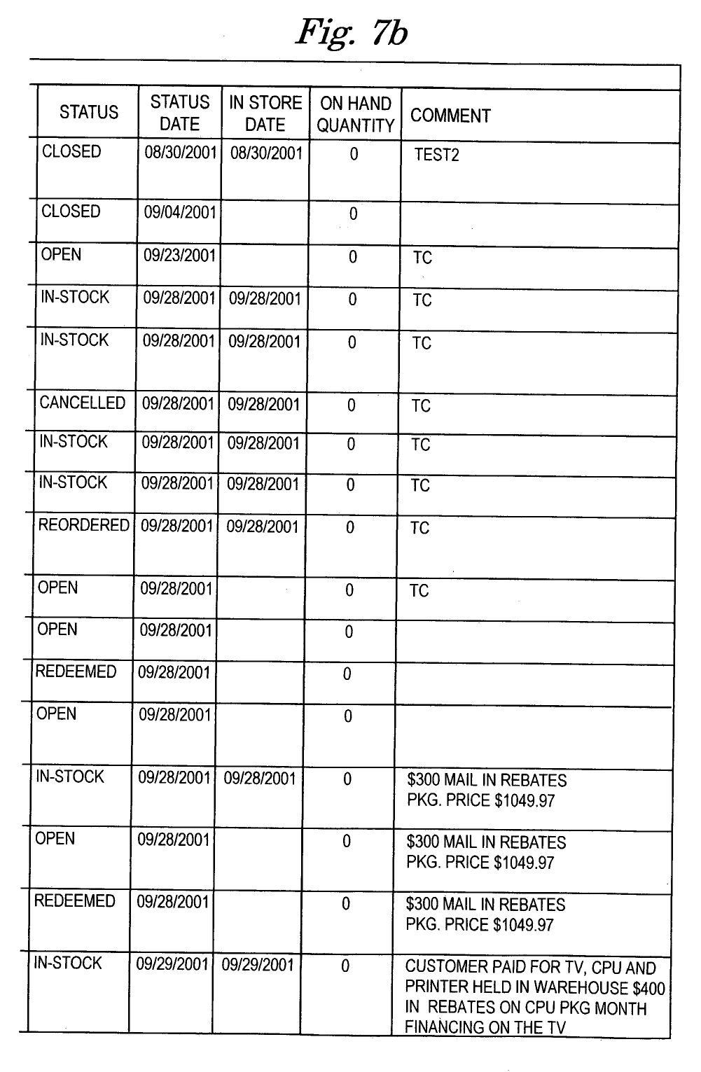

Once the raincheck has been generated, the data entered by the store employee resides in the database 140 and can be accessed by others in the retail operation. As indicated in FIG. 2, employees responsible for managing inventory, e.g. “Marketing Inventory Team”, access the database 140 and analyze the store's rainchecks (330). This typically will be done on a periodic, e.g. daily, basis. In response to queries and sort commands, the database generates reports or lists of rainchecks having specified qualities or status (e.g. all newly created rainchecks from a particular store). The inventory team then responds to the store, describing the action that will be taken for the rainchecks submitted by the store (340). This response from the inventory team can be made by updating the datasbase to reflect this action. Typical response actions will be to promptly send stock of the rainchecked items or to advise the store that the item is backordered and will be shipped in the future. The store personnel manage the status of raincheck's using the “Daily Raincheck Activity Report” (350). This report is generated by populating a report template with data from the database 140. A sample Daily Raincheck Activity Report or “Raincheck Order Activity Report” 700 is shown in FIG. 7. It includes the following columns: order number, customer name, sku number, vendor name, model number, product description, status, status date, In-Store date, quantity onhand and comments. The store personnel access this report via screens displayed on their data input and display terminal 150. These screens allow the store personnel to view rainchecks having specified qualities or status; for example, the store personnel on a period basis may print a status report for all open rainchecks. Typically, only the relevant store's rainchecks will appear on the Daily Report 700.

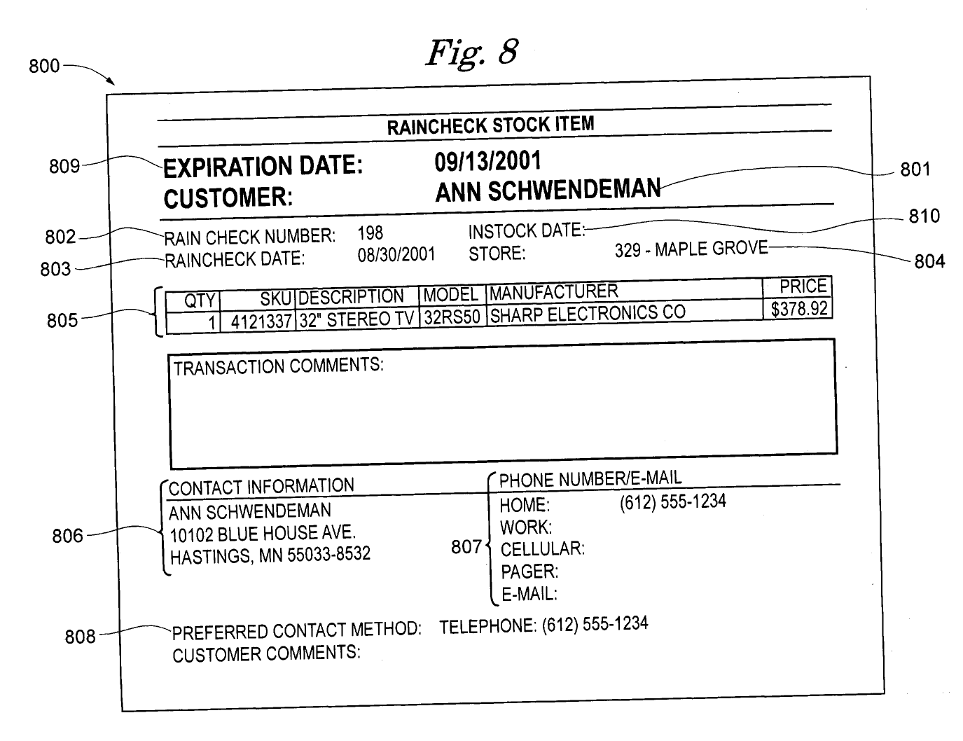

When a store 110 receives stock of rainchecked items, the store personnel will update the database 140 to reflect the “in-stock” status of the appropriate rainchecked items (360). The store personnel will then print (370) an “in-stock sheet” to attach to the product and the labeled product is stored in a storage location 180 at the store. The in-stock sheet is generated by populating a template with data from the database 140. A sample in-stock sheet 800 is illustrated in FIG. 8. The in-stock sheet includes: the customer's name 801; the raincheck number 802; the raincheck date 803; the store identifier 804; an identification of the product 805; address information 806 for the customer; phone information 807 for the customer; an indicator 808 of the customer's preferred method to be notified that the product is in stock. The in-stock sheet also notes the expiration date of the raincheck 809 and the date 810 that the product is received in-stock by the store. Other fields show comments regarding the transaction 811 and the customer's comments 812.

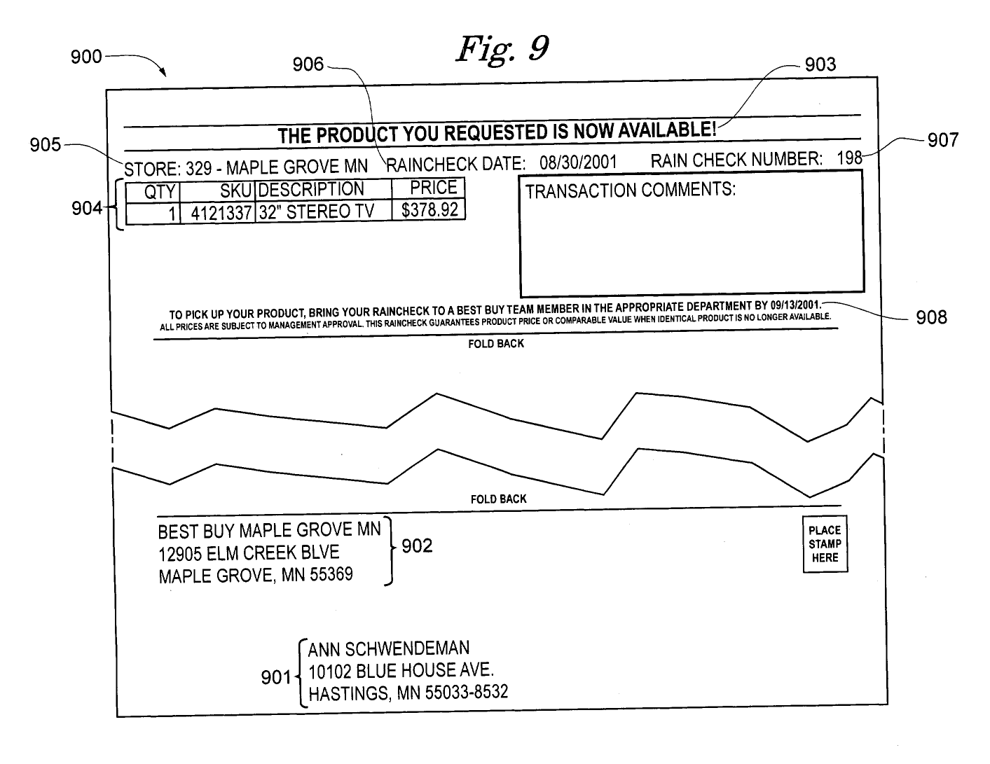

The retail operation advises the customer that their rainchecked item has been received. As noted above, the customer selects a preferred method of notification and this method has been stored in the database along with the information necessary to make the notification via the selected method. If the customer has selected to receive notification by mail (380), the store 110 or the central mail room 132 prints a mailer and sends it to the customer (390). The mailer is generated by printing a mailer template populated with data from specified fields from the databse 140. A sample mailer 900 is illustrated in FIG. 9. The illustrated mailer is a bi-fold post card, though documents of other formats can be used as well. The mailer 900 includes fields for the customer's name and address 901 and a return address 902 to appear on the same side of the post card. On the opposite fold of the mailer 900 is text 903 explaining that the listed item is now available, an identification of the product 904 and identification of the store 905. The mailer 900 also includes the date the raincheck was issued 906 and the raincheck number 907. Further, the mailer 900 includes the date 908 by which the customer must pick up the rainchecked item, i.e. the expiration date of the raincheck. Typically, expiration dates are calculated by the system 100 to be a specified number of days from the notification date.

As shown in FIG. 2, if the customer selected a phone call as his/her preferred notification method (380), then the store personnel, or other employee of the retail operation, calls the customer (400) to inform him/her that the item has arrived. If the customer selected email, the raincheck system 100 generates an email and sends it to the customer (410).

When the customer returns to the store 110 to pick up the rainchecked item (420), the store personnel retrieves the item from storage 180. There are a number of ways that the store personnel can identify the correct item when a customer arrives at the store. The customer may bring the raincheck 600 or the mailer 900 with them. These documents bear identifiers that assist the store personnel in looking up any needed information in the database 140 to match the raincheck to stored items (to which the in-stock sheets are attached). If the customer does not bring these documents with them, the store personnel can look up the raincheck by, for example, executing a search in the database 140 on the customer's name or on any other identifying information the customer can provide such as the product model. In addition, the In-Stock sheet on the stored item assists the employee in identifying the item designated to fulfill the raincheck. The employee can print a replacement raincheck for the customer to take to the register for check out.

With their product in hand, the customer proceeds to a check-out register (430). The cashier charges the customer for the price indicated on the raincheck 600. In a preferred system 100, the raincheck 600 includes a barcode representing the price, the sku, financing options and an indication that it is a raincheck. The cashier then can scan the barcode 608 with a bar code reader connected for data transmission to the register, and the appropriate price is registered for the item. Such a bar code 608 is illustrated in the sample raincheck 600 of FIG. 6. For convenience, this barcode 608 preferably appears on several of the documents associated with the raincheck: the raincheck itself 600, the mailer notification 900, and the in-stock sheet 800. When the transaction is complete, the status of the raincheck in the database 140 is automatically changed to “redeemed” (450), FIG. 2.

If, at decision point 230, the customer does not find a store employee to enter their raincheck information, the customer may fill out a paper raincheck form (460) which the store may make available. Periodically, the store personnel collect the paper rainchecks (470) and enter them into the electronic database system 100. From there, the rainchecks are processed according to the process described above from step 330.

Database

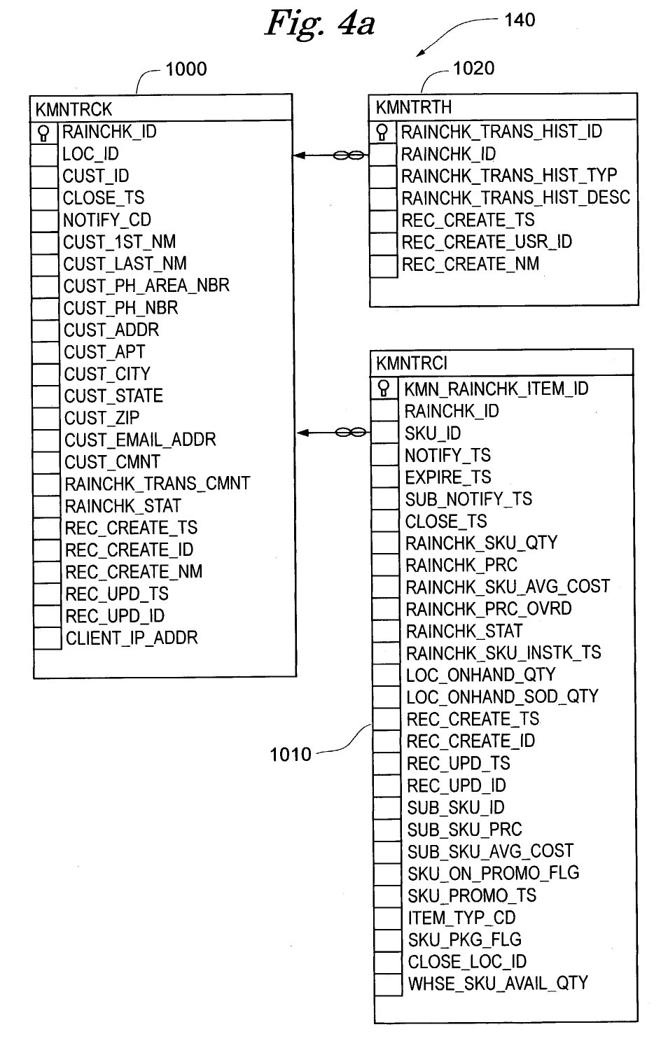

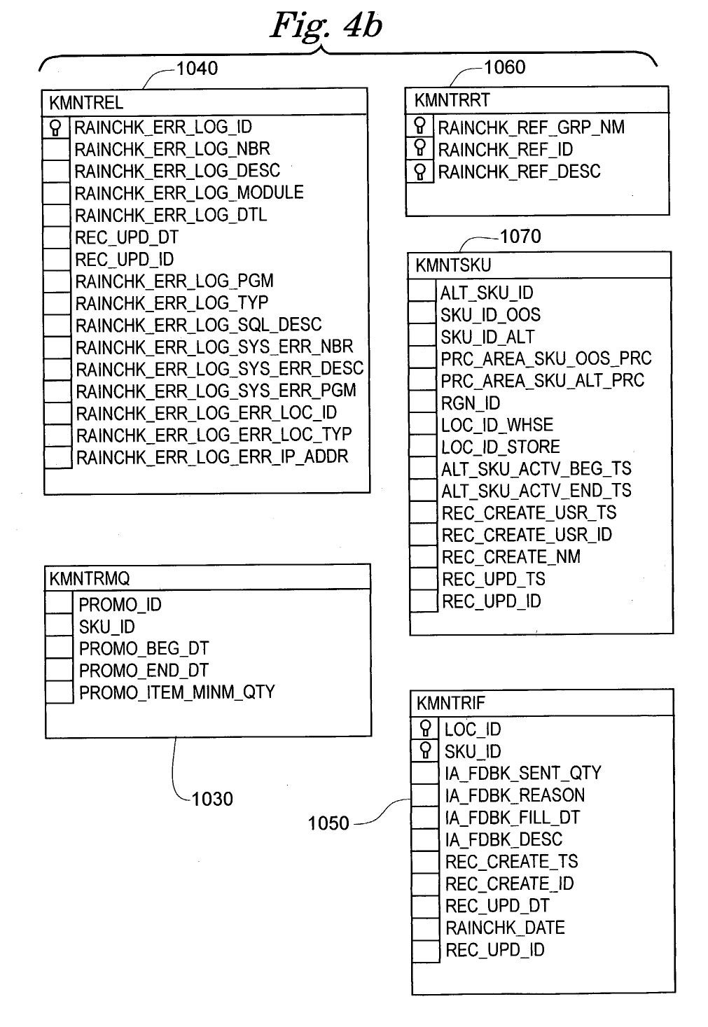

The above-description of the raincheck process 200 liberally references the database 140. The structure of the database 140 will now be described with respect to FIGS. 2 and 4. The database 140 is comprised of several related or linked tables.

As shown in FIGS. 2 and 4, the database 140 includes: a raincheck table 1000, an item table 1010, a transaction table 1020, a promotions table 1030, an error log table 1040, an inventory file table 1050, an internal table 1060 and a product substitutions table 1070.

Turning to FIG. 4, the raincheck table 1000 stores a unique record for each raincheck. The following table, Table 1.0, lists the fields in the raincheck table with a brief explanation of the function of each field.

TABLE 1.0
Raincheck Table

| Field | Explanation | Additional Notes |
|---|---|---|
| RAINCHK_ID | A unique identifier | |
| | assigned to each rain- | |
| | check record | |
| LOC_ID | Identifier for a store | |
| | location | |
| CUST_ID | An unique identifier | Will bring up |
| | for a customer identity | stored informa- |
| | | tion about |
| | | customer if |
| | | customer already |
| | | exists in database |
| CLOSE_TS | “Close Time Stamp” | |
| NOTIFY_CD | Notify code | Identifies the |
| | | method selected |
| | | by the customer |
| | | for receiving no- |
| | | tification of the |
| | | stocking of a rain- |
| | | checked item; |
| | | options include, |
| | | for example, |
| | | email, US mail |
| | | and phone |
| CUST_1ST_NM | Customer's first name | |
| CUST_LAST_NM | Customer's last name | |
| CUST_PH_AREA_NBR | Customer's area code | |
| CUST_PH_NBR | Customer's phone | |
| | number | |
| CUST_ADDR | Customer's address | |
| CUST_APT | Customer's apt | |
| | number | |
| CUST_CITY | Customer's city | |
| CUST_STATE | Customer's state | |
| CUST_ZIP | Customer's zip code | |
| CUST_EMAIL_ADDR | Customer's email | |
| | address | |
| CUST_CMNT | Customer's comments | |
| RAINCHK_TRANS_CMNT | Comment regarding a | |
| | raincheck transaction | |
| RAINCHK_STAT | Raincheck status | E.g. “open”, |
| | | “filled”, “in- |
| | | stock” |
| REC_CREAT_TS | Time/date stamp | |
| REC_CREATE_ID | Identifier of the em- | |
| | ployee who created | |
| | this raincheck record | |
| REC_CREATE_NM | Name of employee | |
| | who created this | |
| | raincheck record | |
| REC_UPD_TS | Updated time/stamp | |
| REC_UPD_ID | Identifier of the em- | |
| | ployee who updated | |
| | this raincheck record | |
| CLIENT_IP_ADDR | Workstation identifier | |

The raincheck item table 1010, FIG. 4, includes records for each item that is rainchecked. A customer may require a raincheck for more than one item; the database 140 provides for a raincheck item record to be created for each item, while only one raincheck record 1000 is created. In other words, the item table 1010 has a many to one relationship with the raincheck table 1000. As indicated, each raincheck item record 1010 includes a field for the raincheck ID. Below is a list of the other fields in the raincheck item table 1010, TABLE 2.0, along with a brief explanation of each field.

TABLE 2.0
Raincheck Item Table

| Field | Explanation | Additional Notes |
|---|---|---|
| KMN_RAINCK_ITEM_ID | Item ID - unique | More than one |
| | to each item that | item may appear |
| | appears on a | on one raincheck |
| | raincheck | |
| RAINCHK_ID | Raincheck ID | Each raincheck |
| | | has a unique ID; |
| | | more than one |
| | | item may appear |
| | | on a raincheck; |
| | | This table is re- |
| | | lated to the Rain- |
| | | check table via a |
| | | many-to-one re- |
| | | lationship through |
| | | the Raincheck ID. |
| SKU_ID | SKU identifier for | |
| | the item | |
| NOTIFY_TS | Time stamp - | Time/date of |
| | notification | notification to |
| | | customer that |
| | | item has been re- |
| | | ceived in stock |
| | | and is available |
| | | for pickup |
| EXPIRE_TS | Time stamp - | Calculated to be |
| | expiration | specified number |
| | | of days after no- |
| | | tification. |
| SUB_NOTIFY_TS | Time stamp - | Date customer |
| | Substitution | was notified the |
| | Notification | original SKU is |
| | | not available, and |
| | | that a substitute |
| | | would be made. |
| CLOSE_TS | Time stamp - | Time/date when |
| | close | the raincheck |
| | | with respect to |
| | | this item is closed |
| | | (e.g. redeemed, |
| | | expired, |
| | | cancelled) |
| RAINCHK_SKU_QTY | Raincheck SKU | Number of items |
| | quantity | for this SKU |
| | | covered by rain- |
| | | check (useful, for |
| | | example, when |
| | | quantity per |
| | | customer is |
| | | limited for pro- |
| | | motional price) |
| RAINCHK_PRC | Price for item | |
| | according to | |
| | raincheck terms | |
| RAINCHK_SKU_AVE_COST | Average cost for | |
| | item | |
| RAINCHK_PRC_OVRD | Raincheck Price | Price actually |
| | Override | charged for the |
| | | product at the |
| | | time of re- |
| | | demption, reflect- |
| | | ing any additional |
| | | discounts taken |
| RAINCHK_STAT | Raincheck status | e.g. open, ex- |
| | for this item | pired, redeemed, |
| | | cancelled |
| RAINCHK_SKU_INSTK_TS | Time stamp | Time/date when |
| | | item was received |
| | | in the store |
| LOC_ONHAND_QTY | Quantity onhand | Used to track |
| | at a given store | rainchecks issued |
| | location at the | when records |
| | time of Raincheck | show ample stock |
| | creation | on hand |
| LOC_ONHAND_SOD_QTY | Quantity onhand | |
| | at the start of a | |
| | day at a given | |
| | store location at | |
| | the time of Rain- | |
| | check creation | |
| REC_CREATE_TS | Time stamp when | |
| | record was | |
| | created | |
| REC_CREATE_ID | Identifier of em- | |
| | ployee who | |
| | created this | |
| | record | |
| REC_UPD_TS | Time stamp | Indicating most |
| | | recent update to |
| | | record |
| REC_UPD_ID | Identifier of em- | |
| | ployee who most | |
| | recently updated | |
| | record | |
| SUB_SKU_ID | Identifier of sku | For store per- |
| | that is an ap- | sonnel to advise |
| | proved substitute | customer of sub- |
| | for the advertised | stitute product in |
| | item | lieu of the adver- |
| | | tised out-of-stock |
| | | item |
| SUB_SKU_PRC | Price for sub- | |
| | stitute SKU | |
| SUB_SKU_AVE_COST | Average cost for | |
| | substitute SKU | |
| SKU_ON_PROMO_FLG | A flag to indicate | |
| | that the item is | |
| | subject to a pro- | |
| | motion at given | |
| | time | |
| SKU_PROMO_TS | Time stamp for | Indicates when |
| | promotion | promotion ends |
| ITEM_TYP_CD | Item type code | |
| SKU_PKG_FLG | Indicates item is | |
| | part of package | |
| | of goods | |
| CLOSE_LOC_ID | Identifier for | Rainchecks need |
| | location where | not be closed in |
| | raincheck was | the same location |
| | closed | as they were |
| | | issued |
| WHSE_SKU_AVAIL_QTY | Quantity of items | |
| | in warehouse | |
| | when raincheck | |
| | was created | |

Table 1020, TABLE 3.0, stores records for each transaction associated with a raincheck. “Transactions” include creation of a raincheck, updating the status of raincheck or modification to other fields, closing of a raincheck. The following table shows the fields in a preferred transaction table 1020 with a brief explanation of each field.

TABLE 3.0
Transaction Table

| Field | Explanation | Additional Notes |
|---|---|---|
| RAINCHK_TRANS_HIST_ID | Raincheck | Each activity cre- |
| | transaction his- | ates one trans- |
| | tory identifier | action record; |
| | | activities include |
| | | the creation of a |
| | | raincheck record, |
| | | updating a rain- |
| | | check record or |
| | | related record, |
| | | closing a rain- |
| | | check record or |
| | | related record |
| RAINCHK_ID | Raincheck ID | Identifies the |
| | | raincheck record |
| | | affected involved |
| | | in the transaction |
| RAINCHK_TRANS_HIST_TYP | Raincheck | Types include |
| | transaction his- | creation, update, |
| | tory type | close |
| RAINCHK_TRANS_HIST_DESC | Raincheck | |
| | transaction his- | |
| | tory description | |
| REC_CREATE_TS | Time stamp for | |
| | creation of | |
| | transaction | |
| | record | |
| REC_CREATE_USR_ID | Identifier for | |
| | the employee | |
| | who entered | |
| | the transaction | |
| REC_CREATE_NM | Name of em- | |
| | ployee who | |
| | entered the | |
| | transaction | |

Table promotions table 1030, TABLE 4.0, stores a record for each promotion offered by the retail operation. It records a unique identifier for each promotion. Each record identifies the product or SKU subject to the promotion terms and stores the beginning and end dates of the promotion. Where a promotion limits the number of items per store that will be available under the promotion (e.g. “Limited quantities availalble” appears in advertisement), that quantity is noted.

TABLE 4.0
Promotions Table

| | | Additional |
|---|---|---|
| Field | Explanation | Notes |
| PROMO_ID | Unique identifier for each | |
| | promotional offer | |
| SKU_ID | Identifier for the sku in- | |
| | volved in the promotion | |
| PROMO_BEG_DT | Beginning date for the | |
| | promotion | |
| PROMO_END_DT | End date for the promotion | |
| PROMO_ITEM_MINM_QTY | Promo item minimum | |
| | quantity | |

The inventory table 1050, TABLE 5.0, stores records used by inventory analysts to generate orders to resupply stock of out-of-stock items to a given store. Preferably, these records store data that can be easily coordinated with a full inventory management system. The fields available in the preferred raincheck system 100 are as follows:

TABLE 5.0
Inventory Table

| Field | Explanation | Additional Notes |
|---|---|---|
| LOC_ID | Identifier for a store lo- | |
| | cation | |
| SKU_ID | Identifier for sku | |
| IA_FDBK_SENT_QTY | Inventory analyst feed- | The inventory |
| | back sent quantity | analyst uses this |
| | | field to indicate |
| | | how many of a |
| | | particular sku |
| | | he/she has or- |
| | | dered to be |
| | | shipped to the |
| | | store location |
| IA_FDBK_REASON | Inventory analyst feed- | Inventory analyst |
| | back reason | gives explanation |
| | | regarding “sent |
| | | quantity”; e.g. |
| | | “sent on truck” |
| IA_FDBK_FILL_DT | Date that inventory | |
| | analyst took action to | |
| | fill inventory of sku | |
| IA_FDBK_DESC | Inventory analyst | |
| | feedback description | |
| REC_CREATE_TS | Time stamp for creation | |
| | of an inventory record | |
| REC_CREATE_ID | Identifier for employee | |
| | who created inventory | |
| | record | |
| REC_UPD_DT | Date of update to | |
| | inventory record | |
| RAINCHK_DATE | Raincheck date of issue | |
| REC_UPD_ID | Identifier for employee | |
| | who updated the | |
| | inventory record | |

It is typical retail practice to make available an alternative product to an advertised item in the event that a store runs out of stock of an advertised item. By including data regarding acceptable substitutes in the raincheck database 140, store personnel can efficiently and properly advise customers of substitute options. In some cases, an alternative product may be made available for the advertised price of the out-of-stock item. Fields associated with a preferred substitution table 1070, TABLE 6.0, are indicated below. They include an identifier for the substitute as well as price for the substitute. A time period is defined by start and end dates during which the substitute is authorized. This period may or may not be the same as the promotion period; thus, a substitute may or may not be an acceptable substitute during the whole promotion period. The screens through which a store employee navigates while creating a raincheck include information regarding these acceptable substitutes. Because management personnel have access to the database 114, the appropriate manager can control the acceptable substitutes through database entries and need not make direct communications to all store personnel.

TABLE 6.0
Substitutions Table

| | | Additional |
|---|---|---|
| Field | Explanation | Notes |
| ALT_SKU_ID | Unique identifier of a | |
| | substitution record | |
| SKU_ID_OOS | Sku of the out of stock | |
| | item | |
| SKU_ID_ALT | Sku of an alternative to | |
| | out-of-stock sku | |
| PRC_AREA_SKU_OOS_PRC | Price in the area for the | |
| | out of stock sku | |
| PRC_AREA_SKU_ALT_PRC | Price in the area for the | |
| | alternative sku | |
| RGN_ID | Region identifier | |
| LOC_ID_WHSE | Identifier for warehouse | |
| | supplying the location | |
| LOC_ID STORE | Identifier for store | |
| | location | |
| ALT_SKU_ACTV_BEG_TS | Time stamp for be- | |
| | ginning of period during | |
| | which the alternative can | |
| | substitute for the out of | |
| | stock sku | |
| ALT_SKU_ACTV_END_TS | Time stamp for end of | |
| | period during which the | |
| | alternative can substitute | |
| | for the out of stock sku | |
| REC_CREATE_USR_TS | Time stamp for the | |
| | creation of a substitution | |
| | record | |
| REC_CREATE_USR_ID | Identifier for employee | |
| | who created substitution | |
| | record | |
| REC_CREAT_NM | Name of employee who | |
| | created substitution | |
| | record | |
| REC_UPD_TS | Time stamp of updates | |
| | to substitution record | |
| REC_UPD_ID | Identifier of employee | |
| | who updated substitution | |
| | record | |

The remainder of the tables (the error log table 1040 and the internal table 1060) are behind-the-scenes tables for the functioning of the database 140.

Software Architecture

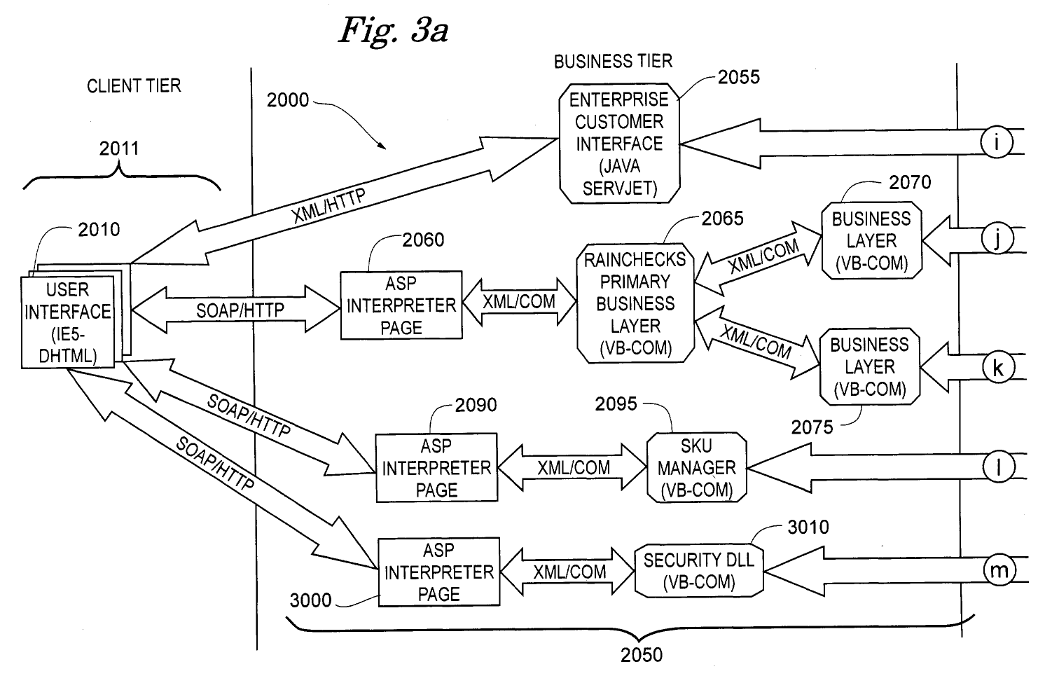

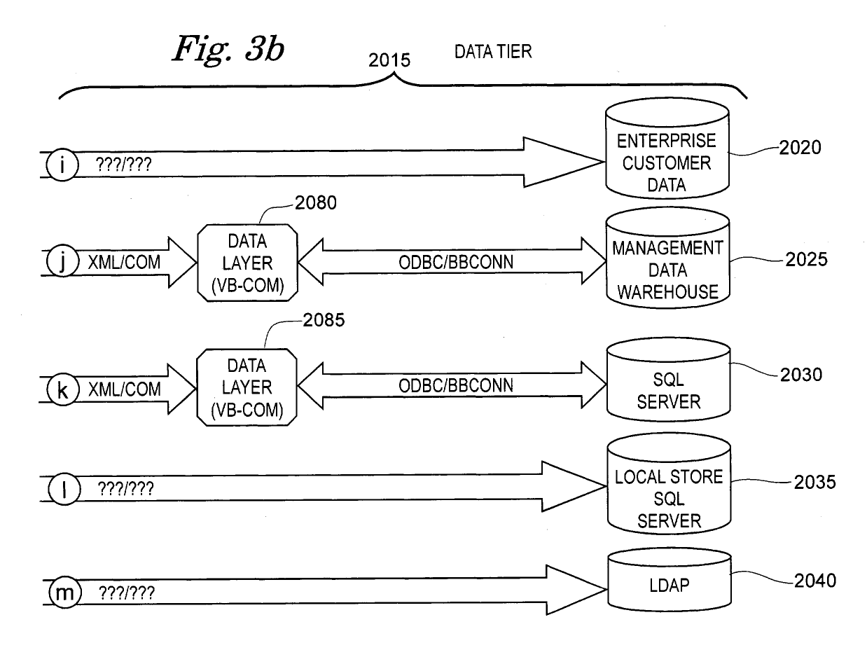

FIG. 3 illustrates an embodiment of software architecture 2000 for implementing the raincheck system 100. According to this architecture, the raincheck system is a software module that functions on its own but which coordinates with other databases, applications and software components used by the retail operation.

A user interface 2010 consists of a number of screens that allow a store employee to enter data, look up data, and view and print rainchecks and reports as described above. Data is transmitted between the user interface 2010 on the client tier 2011 and, ultimately, a data tier 2015. The data tier illustrated includes five data warehouses: 1) the “enterprise customer data” warehouse 2020 where customer information (names, address, email, phone, etc.) is stored for the retail operation and is then available for use throughout the enterprise; 2) the “Management Data Warehouse” 2025 which is used for generating management reports and feeding to an automated forecasting system; 3) the operational application database server 2030 dedicated to supporting the raincheck database 140; 4) the local store database server 2035 which supports the local store; and 5) the “LDAP” Server 2040, an global enterprise security mechanism.

Between the client tier 2011 and each of the five data warehouses 2020, 2025, 2030, 2035, 2040 in the data tier 2015 is a “business tier” 2050. More specifically, the user interface 2010 communicates via XML/http to an Enterprise Customer Interface, a JAVA servlet 2055 which in turn communicates with the enterprise customer data 2020. The user interface 2010 communicates via Simple Object Access Protocol/hypertext transfer protocol (SOAP/http) with an Active Server Page (ASP) interpreter page 2060. This interpreter page 2060 in turn communicates with a Rainchecks Primary Business Layer 2065 which is a Visual Basic-COM layer. The Rainchecks Primary Business Layer communicates with the Management Data warehouse 2025 and the Rainchecks SQL server along two distinct channels, each including a VB-Com Business Layer 2070, 2075 and a VB-Com Data Layer 2080, 2085 communicating via XML/COM. The data layers 2080, 2085 communicate via ODBC/BBConn to the data warehouse 2025 and the raincheck SQL server 2030, respectively.

The user interface 2010 communicates with the local store SQL server 2035 via an ASP interpreter page 2090. Data is transmitted between the user interface 2010 and the interpreter page 2090 via SOAP/http. The interpreter page 2090 communicates to an SKU Manager module 2095, an application in Visual Basic-COM, via XML/COM, which in turn communicates to the local store SQL server 2035.

The user interface 2010 communicates via SOAP/http to another ASP interpreter page 3000 which in turn communicates with a security module 3010, an application written in VB-COM. The security module 3010 in turn communicates to the LDAP 2040 in the data tier 2015.

We claim:

1. A method for creating a raincheck, comprising the steps of:
a) establishing a database having a raincheck table having fields for a customer identifier and a raincheck identifier;
b) creating a raincheck template associated with said database;
c) locating an input and display station in a retail store, said station being connected to said database for data transmission therebetween;
d) locating a printer in the retail store in data connection with said station;
e) at said input and display station, accessing said database and creating a new record and assigning said new record a raincheck identifier;
f) entering a customer identifier into said new record;
g) from said station, sending a command to said database to print a raincheck to said printer using said raincheck template and inserting into said template data associated with said raincheck identifier.

2. A method according to claim 1, further comprising the steps of:
h) establishing a transaction table related to said raincheck table in a many-to-one relationship by the raincheck identifier, such that more than one transaction can be associated with one raincheck identifier.

3. A method according to claim 2, further comprising the steps of:
i) from said station, sending a command to said database to print a raincheck to said printer using said raincheck template and inserting into said template data associated with each transaction associated with said raincheck identifier.

4. A method according to claim 1, further comprising the steps of:
h) establishing an item table related to said raincheck table in a many-to-one relationship by the raincheck identifier, such that more than one item can be associated with one raincheck identifier.

5. A method for fulfilling a raincheck, comprising the steps of:
a) establishing a database having a raincheck table having fields for a customer identifier and a raincheck identifier;
b) issuing a raincheck to a customer for an out-of-stock product and storing a record for said raincheck in said database;
c) creating a notice template for advising the customer that the product has been stocked by generating a message, said notice containing a field for the identity of the product, said field being linked to said raincheck table;
d) generating a notice by populating said template with the product identifier from the raincheck table;
e) providing said notice to the customer.

6. A method according to claim 5, wherein said notice template contains fields for the customer's name and address, and wherein said notice generation includes populating the template with the customer's name and address.

7. A method according to claim 6, wherein said notice is a mailer.

8. A method according to claim 6, wherein said notice is an email message.

9. A method according to claim 5, wherein said step of issuing a raincheck includes printing a bar code on the raincheck, with said bar code uniquely identifying the raincheck and wherein said notice template includes a field for a bar code.

10. A method according to claim 9, further comprising the step of printing said bar code on said notice.

11. A method according to claim 5, further comprising the steps of:
f) creating an in-stock sheet template containing a field for a raincheck identifier and a customer identifier;
g) after receiving a product to fulfill the raincheck, printing an in-stock sheet bearing the raincheck identifier and the customer identifier; and
h) affixing said printed in-stock sheet to the product.

12. A method according to claim 11, wherein said step of issuing a raincheck includes printing a bar code on the raincheck, with said bar code uniquely identifying the raincheck and wherein said in-stock template includes a field for a bar code.

13. A method according to claim 12, further comprising the step of printing the bar code on the in-stock sheet.
